(19) United States
(12) Patent Application Publication
(10) Pub. No.: US 2026/0065707 A1
(43) Pub. Date: Mar. 5, 2026

(54) COMPUTER PROGRAM PRODUCT, INFORMATION PROCESSING METHOD, AND INFORMATION PROCESSING APPARATUS

(71) Applicant: KABUSHIKI KAISHA TOSHIBA, Tokyo (JP)

(72) Inventors: Hirotaka TOKUYAMA, Yokohama (JP); Nao MISHIMA, Inagi (JP); Satoshi ITO, Kawasaki (JP); Tomoki WATANABE, Inagi (JP)

(73) Assignee: KABUSHIKI KAISHA TOSHIBA, Tokyo (JP)

(21) Appl. No.: 19/280,305

(22) Filed: Jul. 25, 2025

(30) Foreign Application Priority Data
Sep. 5, 2024 (JP) 2024-152868

(51) Int. Cl. G06V 40/10; G06Q 30/018; G06V 40/20

(52) U.S. Cl. CPC G06V 40/10; G06Q 30/018; G06V 40/20

(57) ABSTRACT

According to an embodiment, a computer program product includes a non-transitory computer-readable medium including programmed instructions. The instructions cause a computer to execute: acquiring determination logic that determines whether a state represented by a processing target complies with an input rule represented by input rule information; performing, on the processing target, determination processing according to the determination logic; and outputting, to an output device, output information including a determination result by the determination processing.

### CROSS-REFERENCE TO RELATED APPLICATIONS

This application is based upon and claims the benefit of priority from Japanese Patent Application No. 2024-152868, filed on Sep. 5, 2024; the entire contents of which are incorporated herein by reference.

### FIELD

An embodiment described herein relate to a computer program product, an information processing method, and an information processing apparatus.

### BACKGROUND

It is determined whether or not an environment such as a work site or a maintenance site is in a state complying with a rule. For example, a technology of determining a state of a determination target such as a person according to a similarity between an estimated answer estimated for a question regarding a captured image of a manufacturing site or the like and an assumed answer is disclosed.

However, in the related art, it is necessary to prepare a question and an assumed answer to the question and manually adjust determination logic for each environment of the determination target or the like, and thus the determination efficiency may decrease.

### BRIEF DESCRIPTION OF THE DRAWINGS

FIG. 1 is a schematic diagram of an information processing apparatus;

FIG. 2 is a block diagram of a determination logic acquisition unit;

FIG. 3 is a schematic diagram of input rule information;

FIG. 4 is an explanatory diagram of a determination logic case collection;

FIG. 5 is an explanatory diagram of a determination logic case;

FIG. 6 is an explanatory diagram of generation of determination logic;

FIG. 7 is a schematic diagram of determination logic;

FIG. 8A is an explanatory diagram of output of output information;

FIG. 8B is an explanatory diagram of output of output information;

FIG. 8C is an explanatory diagram of output of output information;

FIG. 9 is a flowchart illustrating a flow of information processing; and

FIG. 10 is a hardware configuration diagram.

### DETAILED DESCRIPTION

According to an embodiment, a computer program product includes a non-transitory computer-readable medium including programmed instructions. The instructions cause a computer to execute: acquiring determination logic that determines whether a state represented by a processing target complies with an input rule represented by input rule information; performing, on the processing target, determination processing according to the determination logic; and outputting, to an output device, output information including a determination result by the determination processing.

Hereinafter, an information processing program, an information processing method, and an information processing apparatus according to the present embodiment will be described in detail with reference to the accompanying drawings.

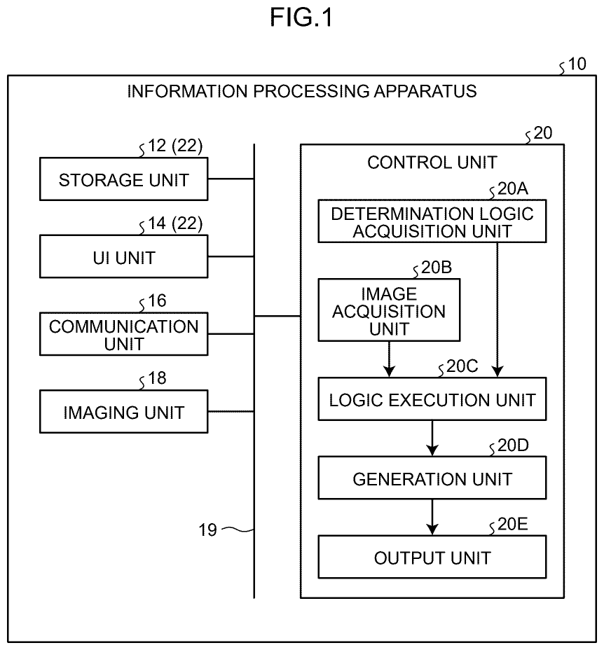

FIG. 1 is a schematic diagram of an example of an information processing apparatus 10 of the present embodiment.

The information processing apparatus 10 includes a storage unit 12, a user interface (UI) unit 14, a communication unit 16, an imaging unit 18, and a control unit 20. The storage unit 12, the UI unit 14, the communication unit 16, the imaging unit 18, and the control unit 20 are communicably connected via a bus 19 or the like. At least one of the storage unit 12, the UI unit 14, and an external information processing apparatus connected to the information processing apparatus 10 via the communication unit 16 functions as an output device 22, which is an output destination that outputs various types of information.

The storage unit 12 stores various types of data. The storage unit 12 may be provided outside the information processing apparatus 10. Alternatively, at least one of the storage unit 12, the UI unit 14, the imaging unit 18, and one or a plurality of functional units included in the control unit 20 to be described later may be mounted on an external information processing apparatus or the like communicably connected to the information processing apparatus 10 via a network or the like.

The UI unit 14 has a display function of displaying various types of information and an input function of receiving an operation input by a user. The display function is, for example, a display, a projection device, or the like. The input function is, for example, a pointing device such as a mouse and a touch pad, a keyboard, or the like. A touch panel in which the display function and the input function are integrally formed may be used.

The UI unit 14 need only be communicably connected to the control unit 20 in a wired or wireless manner. The UI unit 14 may be provided outside the information processing apparatus 10, and the UI unit 14 and the control unit 20 may be connected via a network or the like.

The communication unit 16 is a communication interface for communicating with an information processing apparatus or the like outside the information processing apparatus 10.

The imaging unit 18 acquires captured image data by imaging. The imaging unit 18 outputs captured image data acquired by imaging to the control unit 20.

Hereinafter, the captured image data may be simply referred to as an image.

The imaging angle of view, the imaging direction, and the installation position of the imaging unit 18 are adjusted in advance such that a state of a determination target in the information processing apparatus 10 of the present embodiment can be imaged.

The determination target is a target for which it is determined whether or not an input rule is complied with in the information processing apparatus 10 of the present embodiment. The input rule is information representing a predetermined rule. Details of the input rule will be described later. Examples of the determination target include, but are not limited to, a device, an object, a living body such as a person, a machine, various events existing in nature, and the like. In the present embodiment, a case where the determination target is a person will be assumed.

The state of the determination target is a state of the target for which it is determined whether or not the input rule is complied with in the information processing apparatus 10 of the present embodiment. The state of the determination target corresponds to the input rule. For example, the state of the determination target is a state of a determination target such as a person. Specifically, for example, the state of the determination target is information representing whether or not a person performing specific work wears wearing items such as gloves or the like, but is not limited thereto.

For example, the imaging unit 18 sequentially executes imaging in time series and sequentially outputs images acquired by imaging to the control unit 20. The imaging unit 18 may be provided outside the information processing apparatus 10. In this case, the imaging unit 18 may be communicably connected to the control unit 20 via the communication unit 16 or the like.

The control unit 20 executes information processing in the information processing apparatus 10. The control unit 20 includes a determination logic acquisition unit 20A, an image acquisition unit 20B, a logic execution unit 20C, a generation unit 20D, and an output unit 20E.

The determination logic acquisition unit 20A, the image acquisition unit 20B, the logic execution unit 20C, the generation unit 20D, and the output unit 20E are realized by, for example, one or a plurality of processors. For example, each of the above-described units may be realized by causing a processor such as a central processing unit (CPU) to execute a program, that is, by software. Each of the above-described units may be realized by a processor such as a dedicated IC or circuit, that is, hardware. Each of the above-described units may be realized by using software and hardware in combination. In the case of using a plurality of processors, each processor may realize one of the respective units, or may realize two or more of the respective units.

The determination logic acquisition unit 20A acquires determination logic.

The determination logic is logic for executing determination processing of determining whether or not the state of the determination target represented by a processing target complies with an input rule represented by input rule information. Logic is a term related to programming and represents a processing content, a processing procedure, and a processing method of a program. For example, the determination logic is designed to be able to execute various types of processing by subdividing the input rule into one or a plurality of determination criteria and inputting a processing target. The determination logic may be designed as various forms of algorithms or scripts describing the algorithms, such as decision trees, logical expressions, logical operations, and Python code. In the present embodiment a case where a decision tree is used as the determination logic will be described as an example. Further detailed description of the determination logic will be described later.

The processing target is data capable of representing the state of the determination target described above. The processing target need only be data representing the state of the determination target. For example, the processing target is data such as an image acquired by imaging the state of the determination target, a voice representing the state of the determination target, a point group representing the state of the determination target, and a waveform or a signal representing the state of the determination target. In the present embodiment, a mode in which the processing target is an image acquired by imaging the determination target and captured by the imaging unit 18 will be described as an example.

The input rule information is information representing an input rule. The input rule is a rule desired by the user and input or set by the user. In other words, the input rule is a rule for which the user desires to determine whether or not the state of the determination target represented by the processing target complies with that rule.

The determination logic acquisition unit 20A generates determination logic based on the input rule information. In the present embodiment, the determination logic acquisition unit 20A generates the determination logic based on the input rule information and determination logic case collection.

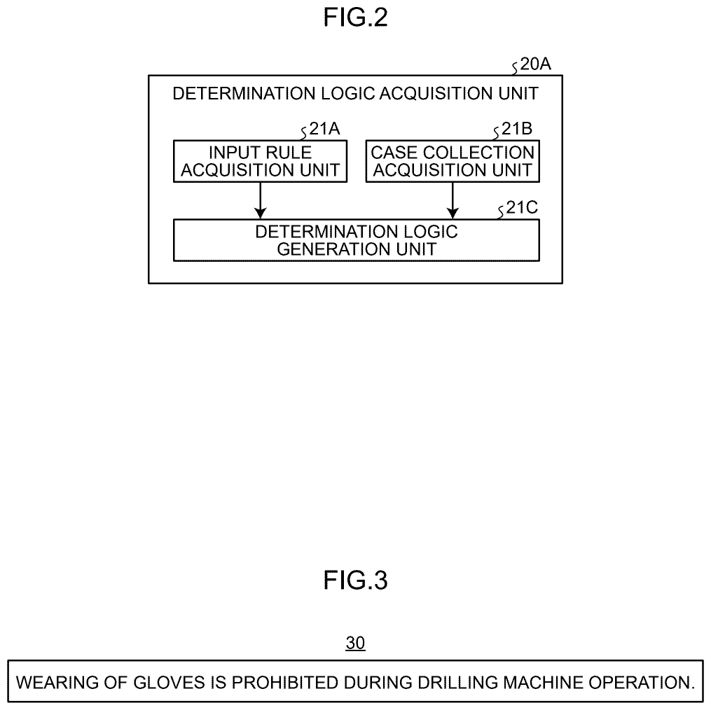

FIG. 2 is a block diagram illustrating an example of a configuration of the determination logic acquisition unit 20A.

The determination logic acquisition unit 20A includes an input rule acquisition unit 21A, a case collection acquisition unit 21B, and a determination logic generation unit 21C. The input rule acquisition unit 21A, the case collection acquisition unit 21B, and the determination logic generation unit 21C are realized by, for example, one or a plurality of processors. For example, each of the above-described units may be realized by causing a processor such as a CPU to execute a program, that is, by software. Each of the above-described units may be realized by a processor such as a dedicated IC or circuit, that is, hardware. Each of the above-described units may be realized by using software and hardware in combination. In the case of using a plurality of processors, each processor may realize one of the respective units, or may realize two or more of the respective units.

The input rule acquisition unit 21A acquires the input rule information. For example, the user inputs desired input rule information by operating the UI unit 14. The input rule acquisition unit 21A acquires the input rule information by receiving the input rule information input by an operation instruction or the like of the UI unit 14 by the user. The input rule acquisition unit 21A may also acquire the input rule information by reading the input rule information stored in advance in the storage unit 12. The input rule acquisition unit 21A may also acquire the input rule information by receiving the input rule information from an external information processing apparatus or the like communicably connected to the information processing apparatus 10 via the communication unit 16.

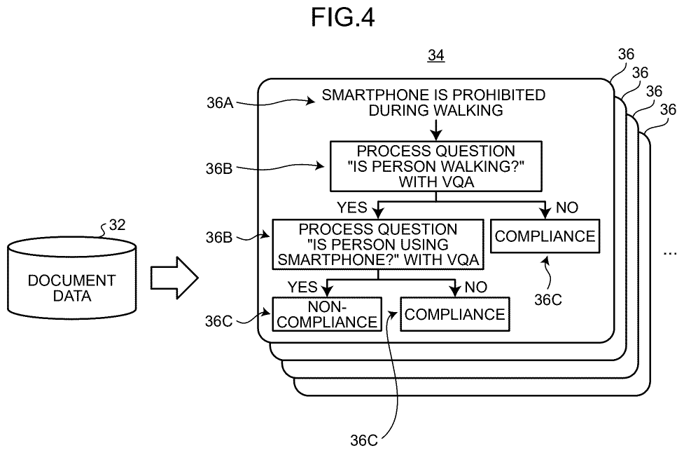

FIG. 3 is a schematic diagram of an example of input rule information 30. In the present embodiment, a case where the input rule information 30 is information representing an input rule “wearing of gloves is prohibited during drilling machine operation” will be described as an example.

Returning to FIG. 2, the description will be continued.

The case collection acquisition unit 21B acquires a determination logic case collection.

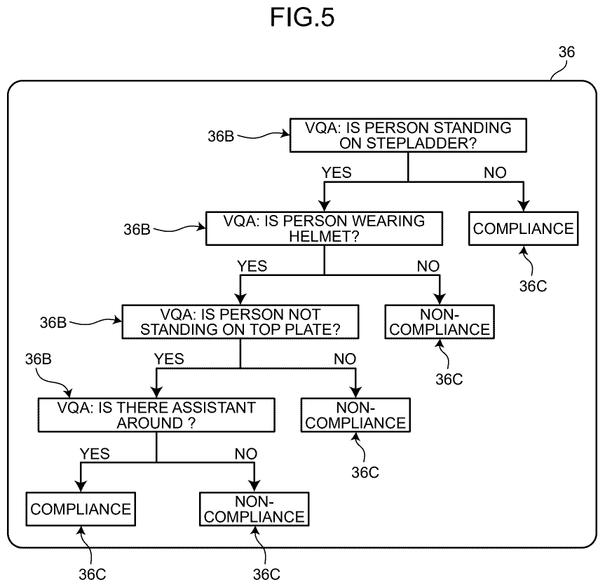

FIG. 4 is an explanatory diagram of an example of generation of a determination logic case collection 34.

The determination logic case collection 34 is logic consisting of a group of one or a plurality of determination logic cases 36. Each determination logic case 36 is logic representing a case of the determination logic.

The determination logic case collection 34 is generated based on document data 32.

The document data 32 is data in which a plurality of types of assumed rules related to the input rule represented by the input rule information 30 is defined.

The document data 32 is, for example, data of a manual or a document applied to an environment in which the determination target such as a person can exist. The environment is, for example, a specific space in a real space such as a work site, a construction site, or an office.

The assumed rule is one or a plurality of rules that can be applied to the environment or can be assumed for the environment, and preferably includes a rule related to the input rule. Relating to the input rule means matching or being similar to the input rule.

The determination logic case 36 is designed such that an assumed rule 36A included in the document data 32 is subdivided to be one or a plurality of determination criteria, and various processing can be executed by inputting a processing target such as an image. The determination logic case 36 may be designed as various forms of algorithms or scripts describing the algorithms, such as decision trees, logical expressions, and Python code.

In the present embodiment, a case where a decision tree is used as the determination logic case 36 will be described as an example. Specifically, in the present embodiment, the determination logic case 36 defines, with respect to the assumed rule 36A extracted from the document data 32, one or a plurality of first processing elements 36B, an execution order of the plurality of first processing elements 36B in a case where the plurality of first processing elements 36B is included, a processing method used for processing of the first processing elements 36B, and a possible first determination result 36C.

Each first processing element 36B represents processing to be executed on the processing target such as an image in order to determine whether or not the assumed rule 36A is complied with. A group of one or a plurality of the first processing elements 36B included in the determination logic case 36 defines determination processing to be executed by the determination logic case 36. The first processing elements 36B include a judgment process, a processing process, and the like. FIG. 4 illustrates, as an example, a case where all the first processing elements 36B included in the determination logic case 36 are judgment processes. Each first processing elements 36B may include a processing method used for the processes. Examples of the processing method include, but are not limited to, object detection, visual question answering (VQA), and the like.

The first determination result 36C is information representing a processing result by the first processing element 36B, that is, a determination result that can be obtained by the determination processing represented by the determination logic case 36. In the present embodiment, the possible first determination result 36C includes compliance representing compliance with the assumed rule 36A and non-compliance representing non-compliance with the assumed rule 36A. Compliance means that the rule is complied with. Non-compliance means that the rule is not complied with.

In the example illustrated in FIG. 4, the execution order of the first processing elements 36B is represented by arrows connecting the plurality of first processing elements 36B as an example. That is, when a decision tree is used in the determination logic case collection 34, each of one or a plurality of the first processing elements 36B constituting the decision tree corresponds to a node, and a direction from a parent node to a child node corresponds to the execution order of the first processing elements 36B.

The case collection acquisition unit 21B analyzes the document data 32 and extracts one or a plurality of the assumed rules 36A included in the document data 32. Then, for each of the extracted assumed rules 36A, the case collection acquisition unit 21B generates the determination logic case 36 for determining whether or not the assumed rule 36A is complied with.

For example, the case collection acquisition unit 21B generates the determination logic case collection 34 by using learned large language models (LLM) having a capability called in-context learning using the document data 32 and a format of the determination logic case 36 represented by the decision tree as illustrated in FIG. 4, and inputting the document data 32 to the LLM.

In-context learning is one of the capabilities of a learning model such as LLM and means a capability to execute a new task based on the context of provided data. In this case, the LLM can understand and output a new task based on an in-context context, which is input data, by recognizing and learning a pattern from a regular document or context.

Examples of the LLM include bidirection encoder representation from transformers (BERT) and generative pre-trained transformer (GPT).

In LLM having a capability called in-context learning, processing desired to be executed by the LLM is given in advance as an instruction, an example of input/output data is given next, and desired input data is given last, so that data having contents in accordance with the context of the above-described data can be output. The example of the input/output data described above may be referred to as an in-context example.

Specifically, the case collection acquisition unit 21B uses the document data 32 as an in-context example. Specifically, the case collection acquisition unit 21B extracts a plurality of the assumed rules 36A included in the document data 32 as in-context examples. Then, the case collection acquisition unit 21B inputs an instruction such as “generate the determination logic case 36 from the assumed rule 36A” to the LLM. Then, the case collection acquisition unit 21B inputs the assumed rule 36A, the first processing elements 36B represented by the determination logic case 36, the execution order of the first processing elements 36B, and a template representing the first determination result 36C to the LLM as in-context examples. Then, the case collection acquisition unit 21B finally inputs the assumed rule 36A to the LLM to acquire the determination logic case 36 for each assumed rule 36A. The case collection acquisition unit 21B executes these processes for each assumed rule 36A so as to generate the determination logic case collection 34.

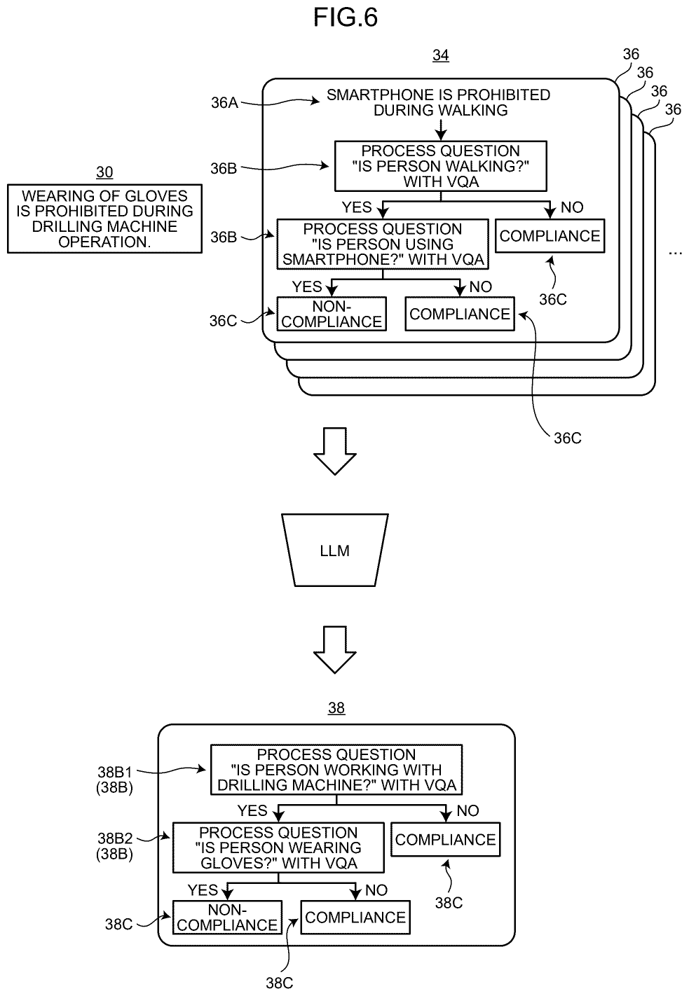

The determination logic cases 36 included in the determination logic case collection 34 need only be generated for each assumed rule 36A included in the document data 32, and is not limited to the mode illustrated in FIG. 4. For example, the determination logic cases 36 included in the determination logic case collection 34 may include determination logic cases of various patterns such as the determination logic case 36 illustrated in FIG. 5 and determination logic 39 to be described later.

Returning to FIG. 4, the description will be continued.

For example, it is assumed that the document data 32 includes “smartphone is prohibited during walking” as the assumed rule 36A. In this case, the case collection acquisition unit 21B performs the above-described processing to generate the determination logic case 36 from which the following first determination result 36C is obtained in the following manner: after the first processing element 36B representing “process the question ‘is the person walking?’ with VQA” is executed, if the result by the first processing element 36B is Yes, the first processing element 36B representing “process the question ‘is the person using the smartphone?’ with VQA” is executed, and if the result by the first processing element 36B is Yes, the first determination result 36C indicating “non-compliance” can be obtained, and if the result is No, the first determination result 36C indicating “compliance” can be obtained. In addition, for other assumed rules 36A included in the document data 32, the case collection acquisition unit 21B generates the determination logic case 36 for each of the assumed rules 36A included in the document data 32 by executing similar processing.

The case collection acquisition unit 21B may also acquire, based on the document data 32, the determination logic case collection 34 including one or a plurality of the determination logic cases 36 input by an operation instruction of the UI unit 14 by the user. For example, it is assumed that the assumed rule 36A included in the document data 32 is “when A is performed, B must not be performed”, “B is prohibited while A is performed”, or the like. In this case, the user may input the determination logic case collection 34 according to a template that defines information such as “1. process A with VQA, 2. process B with VQA, and if the judgment results of A and B are Yes, non-compliance is determined”.

The case collection acquisition unit 21B may also acquire the determination logic case collection 34 by receiving the determination logic case collection 34 generated by an external information processing apparatus communicably connected to the information processing apparatus 10 via the communication unit 16.

The case collection acquisition unit 21B may also acquire the determination logic case collection 34 by reading, from the storage unit 12, the determination logic case collection 34 created in advance and stored in the storage unit 12. The case collection acquisition unit 21B may also acquire the determination logic case collection 34 by receiving the determination logic case collection 34 generated by an external information processing apparatus or the like.

Returning to FIG. 2, the description will be continued.

The determination logic generation unit 21C generates determination logic based on the input rule information 30 and the determination logic case collection 34.

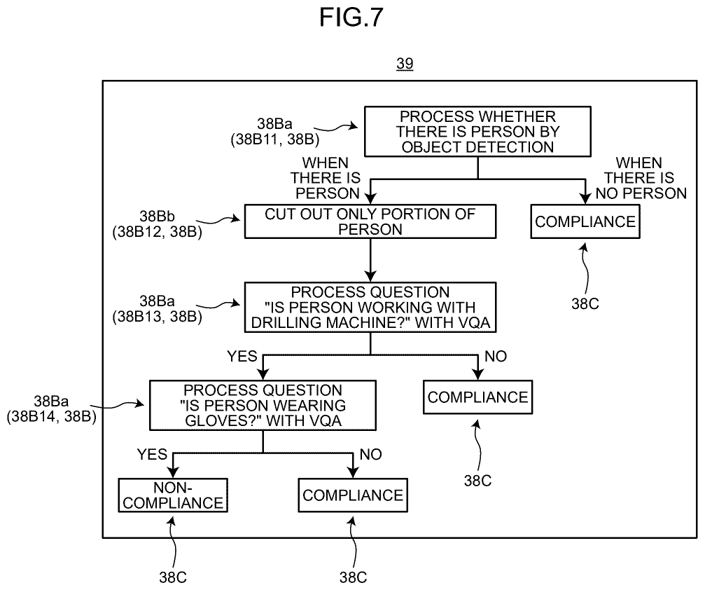

FIG. 6 is an explanatory diagram of an example of generation of determination logic 38.

The determination logic generation unit 21C generates the determination logic 38 that determines an input rule represented by the input rule information 30 according to a determination pattern represented by the determination logic case collection 34.

For example, the determination logic generation unit 21C uses learned LLM having a capability called in-context learning using the input rule information 30 and the determination logic case collection 34 and inputs the input rule information 30 and the determination logic case collection 34 to the LLM. Then, the determination logic generation unit 21C acquires the determination logic 38 as an output from the LLM. That is, the determination logic generation unit 21C generates the determination logic 38 for obtaining, from the processing target, a determination result by the determination processing in accordance with the context of the input rule represented by the input rule information 30, according to the determination pattern represented by the determination logic case collection 34.

As described above, the determination logic 38 is logic for determining whether or not the state of the determination target represented by the processing target such as an image complies with the input rule represented by the input rule information 30. In addition, in the present embodiment, a case where a decision tree is used for the determination logic will be described as an example.

For example, the determination logic generation unit 21C inputs an instruction “generate the determination logic 38 from the input rule information 30” to the LLM. Then, the determination logic generation unit 21C inputs the determination logic case collection 34 to the LLM as an in-context example. Then, the determination logic generation unit 21C finally inputs the input rule information 30 to the LLM to acquire the determination logic 38 as an output from the LLM. Through these processes, the determination logic generation unit 21C generates the determination logic 38 that determines the input rule information 30 according to the determination pattern represented by the determination logic case collection 34.

In the present embodiment, the determination logic 38 defines one or a plurality of second processing elements 38B, an execution order of the plurality of second processing elements 38B when the plurality of second processing elements 38B is included, a processing method used for processing of the second processing elements 38B, and a possible second determination result 38C.

Each second processing element 38B represents processing to be executed on the processing target such as an image in order to determine whether or not the input rule represented by the input rule information 30 is complied with. A group of one or a plurality of the second processing elements 38B included in the determination logic 38 defines determination processing to be executed by the determination logic 38. The second processing elements 38B include a judgment process, a processing process, and the like. Each second processing element 38B may include a processing method used for the process. Examples of the processing method include, but are not limited to, object detection, VQA, and the like.

The second determination result 38C is information representing a processing result by the second processing element 38B which is determination processing, that is, a determination result that can be obtained by the determination processing. In the present embodiment, the possible second determination result 38C includes compliance representing compliance with the input rule and non-compliance representing non-compliance with the input rule.

In the example illustrated in FIG. 6, the execution order of the second processing elements 38B is represented by arrows connecting the plurality of second processing elements 38B as an example. That is, when a decision tree is used in the determination logic 38, each of one or a plurality of the second processing elements 38B constituting the decision tree corresponds to a node, and a direction from a parent node to a child node corresponds to the execution order of the second processing elements 38B. FIG. 6 illustrates, as an example, an execution order in which a second processing element 38B2 which is a child node of a second processing element 38B1 is executed after the second processing element 38B1 which is a parent node is executed. The second processing element 38B1 and the second processing element 38B2 are examples of the second processing elements 38B.

In the case of the determination logic 38 illustrated in FIG. 6, it is defined that the input rule information 30 representing the input rule “wearing of gloves is prohibited during drilling machine operation” is classified into two second processing elements 38B representing “is the person working with a drilling machine?” and “is the person wearing gloves?”, and two judgment processes “process the question of the second processing element 38B1 ‘is the person working with a drilling machine?’ with VQA” and “process the question of the second processing element 38B2 ‘is the person wearing gloves?’with VQA” are sequentially executed using VQA.

The determination logic 38 generated based on the input rule information 30 and the determination logic case collection 34 is not limited to the mode illustrated in FIG. 6.

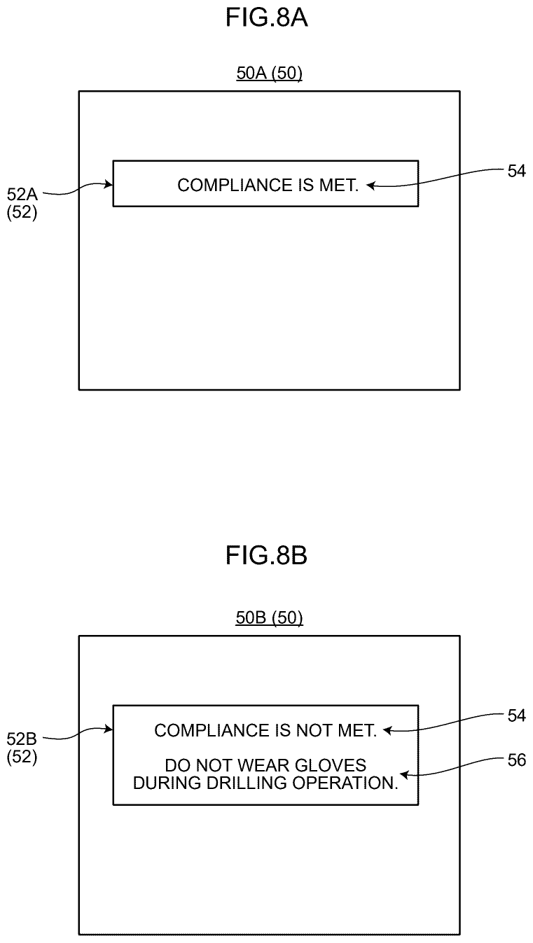

FIG. 7 is a schematic diagram of an example of the determination logic 39 which is another determination logic.

FIG. 7 illustrates an example in which the determination logic 39 includes a second processing element 38Ba which is a judgment process and a second processing element 38Bb which is a processing process, as the second processing element 38B. In addition, FIG. 7 illustrates, as an example, an execution order in which a second processing element 38B11 which is a parent node, the second processing element 38B11 which is a child node of the second processing element 38B11, a second processing element 38B12 which is a child node of the second processing element 38B11, a second processing element 38B13 which is a child node of the second processing element 38B12, and a second processing element 38B14 which is a child node of the second processing element 38B13 are executed in this order. The second processing element 38Ba, the second processing element 38Bb, and the second processing element 38B11 to the second processing element 38B14 are examples of the second processing element 38B.

As illustrated in FIG. 7, the second processing element 38B may further include a processing process as the second processing element 38B. That is, the determination logic acquisition unit 20A may use the determination logic 39 instead of the determination logic 38. The processing process is processing of “cutting out only the portion of the person” or the like, but is not limited to this process. In addition, as illustrated in FIG. 7, the judgment result of the second processing element 38Ba, which is a judgment process, may be “whether or not there is a person”, and is not limited to the form of Yes or No.

In the present embodiment, a mode in which the determination logic acquisition unit 20A generates and acquires the determination logic 38 will be described as an example.

Returning to FIG. 2, the description will be continued.

The determination logic generation unit 21C may generate the determination logic 38 based on the input rule information 30 and the document data 32. For example, the determination logic generation unit 21C may generate the determination logic 38 in the same manner as described above by using LLM having a capability called in-context learning using the document data 32 and a template representing the determination logic 38 represented by the decision tree or the like as illustrated in FIG. 6, and inputting the input rule information 30 and the document data 32 to the LLM.

Returning to FIG. 1, the description will be continued.

In this manner, the determination logic acquisition unit 20A acquires the determination logic 38 by generating the determination logic 38 based on the input rule information 30.

The determination logic acquisition unit 20A may acquire the determination logic 38 by receiving the determination logic 38 generated by an external information processing apparatus or the like from the information processing apparatus or the like via the communication unit 16. The determination logic acquisition unit 20A may also acquire the determination logic 38 by reading the determination logic 38 stored in advance in the storage unit 12.

The image acquisition unit 20B acquires a processing target. As described above, in the present embodiment, a mode in which an image captured by the imaging unit 18 is used as a processing target will be described as an example. Therefore, in the present embodiment, the image acquisition unit 20B acquires an image captured by the imaging unit 18 as the processing target. The image acquisition unit 20B may sequentially acquire, from the imaging unit 18, images sequentially captured by the imaging unit 18. The image acquisition unit 20B may also sequentially acquire each frame constituting a moving image or a video captured by the imaging unit 18 as an image. The image acquisition unit 20B may also acquire a plurality of images captured from multiple viewpoints at the same time. The image acquisition unit 20B may also acquire an image by reading, from the storage unit 12, an image captured by the imaging unit 18 and stored in the storage unit 12. The image acquisition unit 20B may also acquire an image by receiving an image from an external information processing apparatus that stores an image captured by the imaging unit 18 via the communication unit 16.

The logic execution unit 20C executes determination processing according to the determination logic 38 on the image, which is the processing target, acquired by the image acquisition unit 20B. Executing the determination processing according to the determination logic 38 means executing the determination logic 38 on the processing target.

Specifically, the logic execution unit 20C executes the determination processing according to the determination logic 38 by sequentially executing, on the image, the determination processing represented by each of the plurality of second processing elements 38B included in the determination logic 38 in the execution order defined by the determination logic 38. The logic execution unit 20C need only execute the determination logic 38 on the processing target by a processing method using a learned neural network such as VQA and object detection represented by the second processing element 38B. The logic execution unit 20C may also execute the determination logic 38 using a technology such as visual programming that combines a plurality of modules from the input rule information 30 to perform a target process. The logic execution unit 20C may also execute the determination processing represented by the determination logic 38 by constructing a processing flow or the like according to the determination logic 38.

The logic execution unit 20C executes the determination processing according to the determination logic 38 on the image to obtain, as a second determination result 38C, a determination result indicating whether or not the state of the determination target included in the image complies with the input rule represented by the input rule information 30.

The generation unit 20D generates output information including a determination result by the determination processing according to the determination logic 38 on the image which is the processing target.

The output information is information to be output to the output device 22. The output information includes information representing a determination result of the processing target such as an image by the determination logic 38.

For example, it is assumed that the logic execution unit 20C executes the determination processing according to the determination logic 38 illustrated in FIG. 6 on the image which is the determination target. In this case, the logic execution unit 20C executes the processing of the plurality of second processing elements 38B represented by the determination logic 38 on the image in the execution order defined by the determination logic 38.

The generation unit 20D generates generation information including a determination result “compliance” or “non-compliance” which is a determination result represented by the second determination result 38C obtained by executing the determination processing according to the determination logic 38.

When the determination result indicates “non-compliance” with the input rule, the generation unit 20D generates correction information for resolving the non-compliance based on at least one of the input rule information 30 and the determination logic 38. Then, the output information further including the correction information is generated.

For example, it is assumed that the logic execution unit 20C executes the determination processing according to the determination logic 38 illustrated in FIG. 6 on the image which is the determination target. Then, it is assumed that the processing of the plurality of second processing elements 38B represented by the determination logic 38 is executed in the execution order defined by the determination logic 38, and the second determination result 38C by the second processing element 38B2 corresponding to a node in the middle or the terminal indicates non-compliance.

In this case, for example, the generation unit 20D generates, as the correction information, information for prompting compliance with the input rule represented by the input rule information 30 based on the input rule information 30. Alternatively, in each of a plurality of the judgment processes represented by the second processing element 38B, the generation unit 20D may generate, as the correction information, information for guiding the determination target such that the second determination result 38C finally indicated indicates compliance. Alternatively, the generation unit 20D may generate, as the correction information, information for guiding the determination target such that the second determination result 38C finally indicated indicates compliance by using at least some of the plurality of second processing elements 38B defined by the determination logic 38.

Alternatively, the generation unit 20D may prepare a template used to generate the correction information in advance and generate the correction information using the template. In this case, the generation unit 20D need only specify the second processing elements 38B in the reverse order from the second processing element 38B determined to be non-compliance backward in the execution order indicated in the determination logic 38, and generate the correction information as a template. When the template is used, the generation unit 20D may use a dedicated database generated from the document data 32.

In addition, the generation unit 20D prepares in advance LLM having a capability referred to as in-context learning using the input rule information 30, the determination logic 38, the second determination result 38C included in the determination logic 38, and a plurality of pieces of correction proposal information which is a proposal of the correction information. Then, the generation unit 20D may input the input rule information 30, at least a part of the determination logic 38, the determination result obtained by executing the determination logic 38, and an example of the correction information to the LLM as an in-context example, and acquire the correction information as an output from the LLM.

The output unit 20E outputs the generation information to the output device 22. As described above, the storage unit 12, the UI unit 14, and an external information processing apparatus connected via the communication unit 16 function as the output device 22. For example, in a case where the output unit 20E displays the output information on a display of the UI unit 14 as the output device 22, a display screen including the output information is displayed on the display.

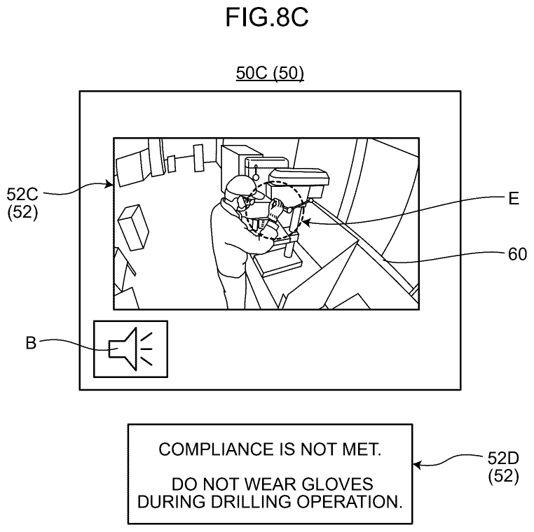

FIG. 8A to 8C are explanatory diagrams of an example of output of output information 52.

FIG. 8A is a schematic diagram of an example of a display screen 50A. The display screen 50A is an example of a display screen 50 displayed on the display of the UI unit 14. For example, it is assumed that a determination result of the determination processing on an image, as a determination target, obtained by executing the determination processing according to the determination logic 38 is information representing compliance with the input rule. In this case, for example, the generation unit 20D generates output information 52A including the information of a determination result 54 indicating the compliance, which is “compliance is met”. The output information 52A is an example of the output information 52. The output unit 20E displays the display screen 50A including the output information 52A on the display of the UI unit 14. The output unit 20E may also output a voice representing the output information 52A from a speaker included in the UI unit 14.

FIG. 8B is a schematic diagram of an example of a display screen 50B. The display screen 50B is an example of the display screen 50 displayed on the display of the UI unit 14. For example, it is assumed that a determination result of the determination processing on an image, as a determination target, obtained by executing the determination processing according to the determination logic 38 is information representing non-compliance with the input rule. In this case, for example, the generation unit 20D generates output information 52B including the information of the determination result 54 indicating the non-compliance, which is “compliance is not met”, and correction information 56 for the non-compliance “do not wear gloves during drilling machine operation”. The output information 52B is an example of the output information 52. The output unit 20E displays the display screen 50A including the output information 52B on the display of the UI unit 14. The output unit 20E may also output a voice representing the output information 52B from a speaker included in the UI unit 14.

FIG. 8C is a schematic diagram of an example of a display screen 50C. The display screen 50C is an example of the display screen 50 displayed on the display of the UI unit 14. For example, it is assumed that a determination result of the determination processing on an image 60, as a determination target, obtained by executing the determination processing according to the determination logic 38 is information representing non-compliance with the input rule. In this case, for example, the generation unit 20D may generate, as output information 52C, a superimposed image acquired by superimposing, on the image 60 used for the determination processing, an emphasis image E that emphasizes a portion representing non-compliance included in the image 60, as the information of the determination result 54 representing non-compliance. In addition, in the same manner as described above, the generation unit 20D generates output information 52D including the information of the determination result 54 representing the non-compliance, which is “compliance is not met”, and the correction information 56 for the non-compliance “do not wear gloves during drilling machine operation”. The output information 52C and the output information 52D are examples of the output information 52.

The output unit 20E displays the display screen 50C including the output information 52C on the display of the UI unit 14. The display screen 50C is an example of the display screen 50. The display screen 50C may also include a button image B for receiving a voice output instruction. When the user operates the UI unit 14 to operate the button image B, the output unit 20E may output, from a speaker included in the UI unit 14, a voice representing the output information 52D including the information of the determination result 54 representing non-compliance, which is “compliance is not met”, and the correction information 56 of the non-compliance “do not wear gloves during drilling machine operation”.

In FIGS. 8A to 8C, a mode in which the output unit 20E outputs a character string or voice representing the output information 52 has been described as an example. However, the output form of the output information 52 is not limited to a character string or voice. For example, the output unit 20E may output an icon, an image, an animation, a warning sound, or the like representing the output information 52.

Next, an example of a flow of information processing executed by the information processing apparatus 10 of the present embodiment will be described.

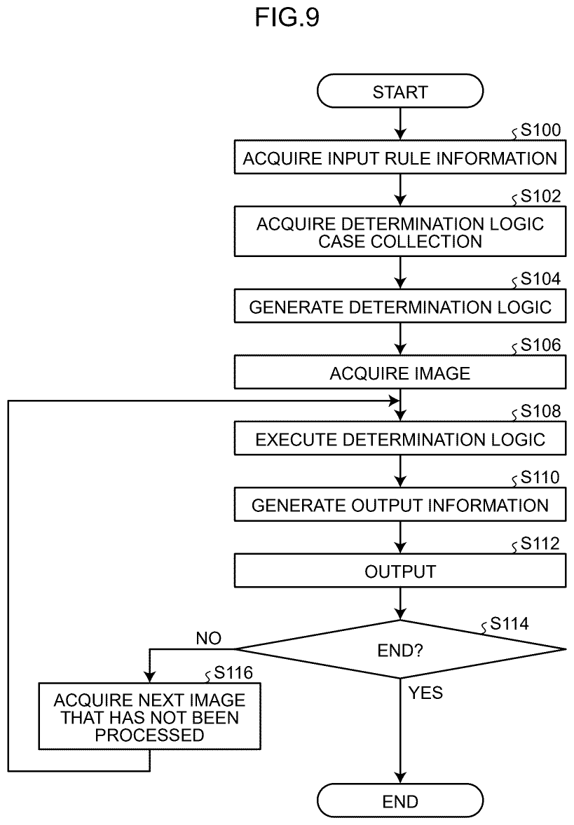

FIG. 9 is a flowchart illustrating an example of a flow of information processing executed by the information processing apparatus 10 of the present embodiment.

The input rule acquisition unit 21A of the determination logic acquisition unit 20A acquires the input rule information 30 (step S100). For example, the input rule acquisition unit 21A acquires the input rule information 30 by receiving, from the UI unit 14, the input rule information 30 input by an operation instruction of the UI unit 14 by the user.

The case collection acquisition unit 21B acquires the determination logic case collection 34 (step S102).

The determination logic generation unit 21C generates the determination logic 38 using LLM or the like based on the input rule information 30 acquired in step S100 and the determination logic case collection 34 acquired in step S102 (step S104).

Next, the image acquisition unit 20B acquires an image from the imaging unit 18 (step S106).

The logic execution unit 20C executes the determination processing according to the determination logic 38 generated in step S104 on the image acquired by the image acquisition unit 20B (step S108).

The generation unit 20D generates the output information 52 according to the result of the determination processing in step S108 (step S110).

The output unit 20E outputs the output information 52 generated in step S112 to the output device 22 (step S112). By the processing of step S112, for example, the output information 52 illustrated in FIGS. 8A to 8B and the like is output to the output device 22.

The control unit 20 determines whether or not to end the processing (step S114). For example, the control unit 20 executes the determination of step S114 by determining whether or not an end signal representing the end of the processing has been received by an operation instruction or the like of the UI unit 14 by the user. When negative determination is made in step S114 (step S114: No), the process proceeds to step S116. In step S116, the image acquisition unit 20B acquires a new image from the imaging unit 18 (step S116), and the process proceeds to step S108. In step 116, the image acquisition unit 20B need only acquire an image on which the determination logic 38 of step S108 has not been executed.

On the other hand, when affirmative determination is made in step S114 (step S114: Yes), this routine is ended.

As described above, the information processing apparatus 10 of the present embodiment includes the determination logic acquisition unit 20A, the logic execution unit 20C, and the output unit 20E. The determination logic acquisition unit 20A acquires the determination logic 38 that determines whether or not the state represented by the processing target (the image 60) complies with the input rule represented by the input rule information 30. The logic execution unit 20C executes, on the processing target, the determination processing according to the determination logic 38. The output unit 20E outputs the output information including a determination result by the determination processing to the output device 22.

In this manner, the information processing apparatus 10 of the present embodiment executes, on the processing target (the image 60), the determination processing according to the acquired determination logic 38 to determine whether or not the state represented by the processing target complies with the input rule represented by the input rule information 30.

Therefore, by inputting the input rule information 30 without manually adjusting or designing the determination logic 38 for each environment or the like of the determination target, the user can receive a determination result as to whether or not the state represented by the processing target complies with the input rule represented by the input rule information 30. In addition, the information processing apparatus 10 can execute, on the processing target, the determination processing according to the determination logic 38 without requiring manual adjustment of the determination logic 38 by the user.

Therefore, the information processing apparatus 10 of the present embodiment can improve the determination efficiency.

In addition, since the information processing apparatus 10 of the present embodiment does not require manual adjustment of the determination logic 38 by the user, it is possible to reduce the load on the user, in addition to the above effects.

In addition, the information processing apparatus 10 of the present embodiment executes, on the processing target (the image 60), the determination processing according to the determination logic 38 to determine whether or not the state represented by the processing target complies with the input rule represented by the input rule information 30. Therefore, in addition to the above effects, the information processing apparatus 10 of the present embodiment can provide the versatile information processing apparatus 10 that can be applied without depending on the environment of the determination target.

In addition, in the present embodiment, the determination logic 38 defines one or a plurality of the second processing elements 38B, an execution order of the second processing elements 38B, a processing method used for processing of the second processing elements 38B, and the possible second determination result 38C.

Therefore, the information processing apparatus 10 of the present embodiment can automatically subdivide the context included in the input rule information 30 and execute the processing represented by the second processing elements 38B for each subdivided item by executing the determination processing according to the determination logic 38 on the input rule information 30.

Therefore, the information processing apparatus 10 of the present embodiment can reduce the load on the user, and it is possible to provide the information processing apparatus 10 applicable to various environments.

In the present embodiment, a mode has been described as an example in which the determination target is a person, the state of the determination target is whether or not the person performing specific work wears wearing items such as gloves, and the input rule represented by the input rule information 30 is “wearing of gloves is prohibited during drilling machine operation”. However, as described above, the determination target may be a device, an object, a living body such as a person, a machine, various events existing in nature, or the like, and is not limited to a person. In addition, the state of the determination target is not limited to information representing whether or not a person performing specific work wears wearing items such as gloves.

For example, the determination target may be a machine, and the state of the determination target may be a state around the machine. For example, the input rule represented by the input rule information 30 may be an input rule, such as “do not place any combustible material in the vicinity when a machine A is operated”, which is related to a state around the “machine A” which is the determination target other than a person.

An application target of the information processing apparatus 10 of the present embodiment is not limited. The information processing apparatus 10 of the present embodiment is applicable to, for example, determination of whether or not various input rules for various environments such as a work site and an office are complied with.

Next, an example of a hardware configuration of the information processing apparatus 10 (the information processing apparatus 10 to an information processing apparatus 10D) according to the above-described embodiment will be described.

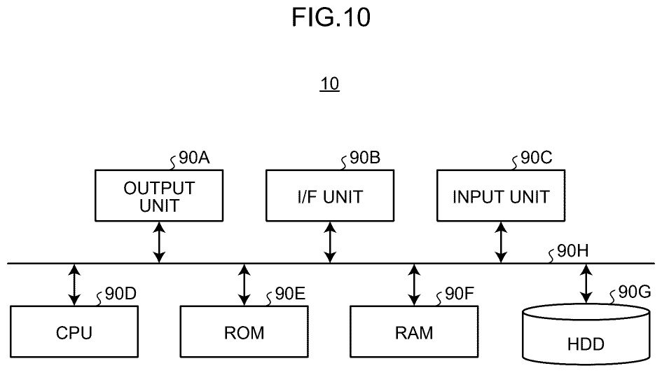

FIG. 10 is a hardware configuration diagram of an example of the information processing apparatus 10 of the above-described embodiment.

The information processing apparatus 10 of the above-described embodiment includes a control device such as a central processing unit (CPU) 90D, a storage device such as a read only memory (ROM) 90E, a random access memory (RAM) 90F, and a hard disk drive (HDD) 90G, an I/F unit 90B that is an interface with various devices, an output unit 90A that outputs various types of information, an input unit 90C that receives an operation by the user, and a bus 90H that connects the respective units, and has a hardware configuration using a normal computer.

In the information processing apparatus 10 of the above-described embodiment, the CPU 90D reads a program from the ROM 90E onto the RAM 90F and executes the program, whereby the above-described units are realized on a computer.

The program for executing each of the above-described processes executed by the information processing apparatus 10 of the above-described embodiment may be stored in the HDD 90G. The program for executing each of the above-described processes executed by the information processing apparatus 10 of the above-described embodiment may also be provided by being incorporated in the ROM 90E in advance.

The program for executing the above-described processes executed by the information processing apparatus 10 of the above-described embodiment may also be stored as a file in an installable format or an executable format in a computer-readable storage medium such as a CD-ROM, a CD-R, a memory card, a digital versatile disc (DVD), or a flexible disk (FD) and provided as a computer program product. The program for executing the above-described processing executed by the information processing apparatus 10 of the above-described embodiment may also be stored on a computer connected to a network such as the Internet and provided by being downloaded via the network. The program for executing the above-described processes executed by the information processing apparatus 10 of the above-described embodiment may also be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computer program product comprising a non-transitory computer-readable medium including programmed instructions, the instructions causing a computer to execute:
acquiring determination logic that determines whether a state represented by a processing target complies with an input rule represented by input rule information;
performing, on the processing target, determination processing according to the determination logic; and
outputting, to an output device, output information including a determination result by the determination processing.

2. The product according to claim 1, wherein
the acquiring includes generating the determination logic based on the input rule information.

3. The product according to claim 2, wherein
the generating the determination logic includes,
based on the input rule information and a determination logic case collection including a group of one or more determination logic cases that is generated from a plurality of types of assumed rules based on document data in which the assumed rules related to the input rule are defined,
generating determination logic that determines the input rule represented by the input rule information, according to a determination pattern represented by the determination logic case collection.

4. The product according to claim 3, wherein
each of the determination logic cases defines, for each of the assumed rules extracted from the document data, one or more first processing elements, an execution order of the first processing elements, a processing method used for processing of the first processing elements, and a possible first determination result.

5. The product according to claim 3, wherein
the generating the determination logic includes generating the determination logic case collection based on the document data.

6. The product according to claim 1, wherein
the determination logic defines one or more second processing elements, an execution order of the second processing elements, a processing method used for processing of the second processing elements, and a possible second determination result.

7. The product according to claim 1, wherein
the instructions causing the computer to execute generating the output information including a determination result by the determination processing, on the processing target, according to the determination logic.

8. The product according to claim 7, wherein
the generating the output information includes, when the determination result indicates non-compliance with the input rule, generating correction information for resolving the non-compliance based on at least one of the input rule information and the determination logic, and generating the output information further including the correction information.

9. An information processing method executed by an information processing apparatus, the method comprising:
acquiring a determination logic that determines whether a state represented by a processing target complies with an input rule represented by input rule information;
performing, on the processing target, determination processing according to the determination logic; and
outputting, to an output device, output information including a determination result by the determination processing.

10. An information processing apparatus comprising
one or more hardware processors configured to:
acquire determination logic that determines whether a state represented by a processing target complies with an input rule represented by input rule information;
perform, on the processing target, determination processing according to the determination logic; and
output, to an output device, output information including a determination result by the determination processing.
